(19) United States
(12) Patent Application Publication
(10) Pub. No.: US 2026/0320809 A1
(43) Pub. Date: Oct. 15, 2026

(54) HOLOGRAM MODEL TRAINING METHOD AND APPARATUS BASED ON UNLABELED SAMPLE TRAINING SET, DEVICE, AND MEDIUM

(71) Applicant: ARMY ACADEMY OF ARMORED FORCES, BEIJING (CN)

(72) Inventors: XINGPENG YAN, BEIJING (CN); JIAQI LI, BEIJING (CN); YANAN ZHANG, BEIJING (CN); HAIRONG HU, BEIJING (CN); TAO JING, BEIJING (CN); HEBIN CHANG, BEIJING (CN); YANG YU, BEIJING (CN)

(21) Appl. No.: 19/251,361

(22) Filed: Jun. 26, 2025

(30) Foreign Application Priority Data
Apr. 14, 2025 (CN) 202510465203.6

(51) Int. Cl. G06T 7/50; G06T 5/10; G06T 5/50; G06V 10/44; G06V 10/88

(52) U.S. Cl. CPC G06T 7/50; G06T 5/10; G06T 5/50; G06V 10/44; G06V 10/88; G06T 2207/10024; G06T 2207/10028; G06T 2207/20221

(57) ABSTRACT

Provided are a hologram model training method and apparatus based on an unlabeled sample training set, a device, and a medium. The hologram model training method includes: obtaining an unlabeled sample training set containing a plurality of red/green/blue-depth (RGB-D) images; iteratively training a hologram model based on the unlabeled sample training set until a preset iteration quantity is reached: in a training process, calculating a multi-depth diffraction field matrix of each RGB-D image in the training set at a preset diffraction distance, and inputting the multi-depth diffraction field matrix into the hologram model to generate a multi-depth hologram; reconstructing the multi-depth diffraction field through layer-by-layer diffraction by using an angular spectrum method (ASM), and obtaining a focus-stacked image; comparing a difference between a target RGB-D image and the focus-stacked image, calculating a model loss, and optimizing a parameter of the hologram model based on the model loss.

### CROSS REFERENCE TO RELATED APPLICATION

This patent application claims the benefit and priority of Chinese Patent Application No. 2025104652036, filed with the China National Intellectual Property Administration on Apr. 14, 2025, the disclosure of which is incorporated by reference herein in its entirety as part of the present application.

### TECHNICAL FIELD

The present disclosure relates to the field of three-dimensional imaging, and in particular, to a hologram model training method and apparatus based on an unlabeled sample training set, a device, and a medium.

### BACKGROUND

Integrating the computer technology and the optical holography, computer generated holography (CGH) can achieve some functions that are difficult and even impossible to be achieved by the optical holography, such as controlling a size of a reproduced object, or reproducing some objects that do not exist yet in physical reality. A main device serving as a replacement for a photosensitive material in the optical holography is a spatial light modulator (SLM).

Current SLMs are predominantly of a phase type, and can only modulate a phase of incident light but not its amplitude. Methods for generating pure phase information from diffraction field information in related technologies include iteration-based algorithms like a Gerchberg-Saxton (GS) algorithm and a Wirtinger Holography (WH) algorithm, as well as one-step encoding algorithms like a double-phase holography (DPH) algorithm and a stochastic gradient descent (SGD) algorithm. These methods generally exhibit a trade-off between reproduction quality and a generation speed. The DPH algorithm achieves a highest generation speed, but its reproduction quality is often not high. It takes a long iterative time for the WH algorithm to generate a hologram with high reproduction quality.

Based on this, the present disclosure provides a hologram model training method and apparatus based on an unlabeled sample training set, a device, and a medium.

### SUMMARY

An objective of the present disclosure is to provide a hologram model training method and apparatus based on an unlabeled sample training set, a device, and a medium, to reduce dependence on a dataset and effectively improve encoding quality and a generation speed of a three-dimensional hologram.

To achieve the above objective, the present disclosure provides following technical solutions.

According to a first aspect, the present disclosure provides a hologram model training method based on an unlabeled sample training set, including:
obtaining an unlabeled sample training set, where the unlabeled sample training set includes a plurality of red/green/blue-depth (RGB-D) images, the RGB-D image is obtained by combining an intensity image and a depth image, the intensity image contains information of red, green, and blue channels, and the depth image contains information of a distance from an object surface to an observation point;
iteratively training a hologram model based on the unlabeled sample training set until a preset iteration quantity is reached:
calculating a multi-depth diffraction field matrix of a target RGB-D image at a preset diffraction distance, where the target RGB-D image is any RGB-D image in the unlabeled sample training set;
inputting the multi-depth diffraction field matrix into the hologram model, and obtaining a multi-depth hologram;
reconstructing a multi-depth diffraction field of the multi-depth hologram through layer-by-layer diffraction by using an angular spectrum method (ASM), and obtaining a focus-stacked image;
calculating a model loss based on the target RGB-D image and the focus-stacked image; and
optimizing a parameter of the hologram model based on the model loss.

According to a second aspect, the present disclosure provides a hologram model training apparatus based on an unlabeled sample training set, including:
a data obtaining module configured to obtain an unlabeled sample training set, where the unlabeled sample training set includes a plurality of RGB-D images, the RGB-D image is obtained by combining an intensity image and a depth image, the intensity image contains information of red, green, and blue channels, and the depth image contains information of a distance from an object surface to an observation point;
an iterative training module configured to iteratively train a hologram model based on the unlabeled sample training set until a preset iteration quantity is reached:
a diffraction field matrix calculation module configured to calculate a multi-depth diffraction field matrix of a target RGB-D image at a preset diffraction distance, where the target RGB-D image is any RGB-D image in the unlabeled sample training set;
a hologram obtaining module configured to input the multi-depth diffraction field matrix into the hologram model, and obtain a multi-depth hologram;
a focus-stacked image obtaining module configured to reconstruct a multi-depth diffraction field of the multi-depth hologram through layer-by-layer diffraction by using an ASM, and obtain a focus-stacked image;
a loss calculation module configured to calculate a model loss based on the target RGB-D image and the focus-stacked image; and
a parameter optimization module configured to optimize a parameter of the hologram model based on the model loss.

According to a third aspect, the present disclosure provides a computer device, including a memory, a processor, and a computer program stored in the memory and executable on the processor, where the processor executes the computer program to perform the steps of the hologram model training method based on an unlabeled sample training set according to any one of the items described above.

According to a fourth aspect, the present disclosure provides a computer-readable storage medium, storing a computer program thereon, where the computer program is executed by a processor to perform the steps of the hologram model training method based on an unlabeled sample training set according to any one of the items described above.

According to specific embodiments provided in the present disclosure, the present disclosure achieves following technical effects:

The present disclosure provides a hologram model training method and apparatus based on an unlabeled sample training set, a device, and a medium. An unlabeled sample training set is obtained, which solves problems of a difficulty in obtaining a large amount of training data and a high annotation cost. The unlabeled sample training set consists of a plurality of RGB-D images, which not only contain rich color information (red, green, and blue channels), but also incorporate depth information, that is, a distance from an object surface to an observation point. The above information together constitutes a key input required for training a hologram model, laying a solid foundation for achieving unlabeled training, making full use of unlabeled RGB-D image resources, and reducing a data preparation cost and difficulty. A multi-depth hologram is obtained by calculating a multi-depth diffraction field matrix of a target RGB-D image at a preset diffraction distance and inputting the multi-depth diffraction field matrix into the hologram model, which solves a problem of how to extract an effective feature from unlabeled data and generate a high-quality hologram. In a process of calculating the multi-depth diffraction field matrix, the depth information of the RGB-D image is fully utilized and converted into a form that can be understood by the neural network model. Through forward propagation of the hologram model, the multi-depth hologram is generated, providing a foundation for subsequent diffraction reconstruction and loss calculation. This not only improves hologram generation efficiency, but also ensures that a generated hologram can accurately reflect three-dimensional structural information of an original RGB-D image. A focus-stacked image is obtained by reconstructing a multi-depth diffraction field of the multi-depth hologram through layer-by-layer diffraction by using an ASM, which solves a problem of how to verify and evaluate quality of the generated hologram. As a result of hologram diffraction reconstruction, quality of the focus-stacked image directly reflects performance of the hologram model. A model loss can be calculated by comparing the focus-stacked image with the original target RGB-D image, and a parameter of the hologram model can be optimized accordingly. The parameter of the hologram model is optimized based on the model loss, thereby achieving a continuous improvement in the performance of the hologram model. This step not only solves a parameter adjustment problem during model training, but also ensures that the hologram model can gradually adapt to a distribution characteristic of the unlabeled data, thereby improving a generalization capability of the hologram model in a real application scenario.

In summary, the hologram model training method based on an unlabeled sample training set in the present disclosure effectively solves a data annotation dependency problem in traditional methods, improves model training efficiency and the quality of the generated hologram, and lays a solid foundation for widespread application of a hologram technology.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a schematic flowchart of a hologram model training method based on an unlabeled sample training set according to an embodiment of the present disclosure;

FIGS. 2A-2B schematically show random matrices with different quantities of height pixels according to an embodiment of the present disclosure, where FIG. 2A schematically shows a random matrix with four height pixels; and FIG. 2B schematically shows a random matrix with 64 height pixels;

FIGS. 3A-3F schematically show intensity images generated by the random matrices of the two height pixel quantities in FIGS. 2A-2B through different interpolation algorithms, where FIG. 3A schematically shows an intensity image generated by the random matrix with four height pixels through a nearest neighbor upsampling (NNU) interpolation algorithm; FIG. 3B schematically shows an intensity image generated by the random matrix with 64 height pixels through the NNU interpolation algorithm; FIG. 3C schematically shows an intensity image generated by the random matrix with four height pixels through a bilinear upsampling (BU) interpolation algorithm; FIG. 3D schematically shows an intensity image generated by the random matrix with 64 height pixels through the BU interpolation algorithm; FIG. 3E schematically shows an intensity image generated by the random matrix with four height pixels through a bicubic upsampling (BCU) interpolation algorithm; and FIG. 3F schematically shows an intensity image generated by the random matrix with 64 height pixels through the BCU interpolation algorithm;

FIGS. 4A-4C schematically shows spectrum distributions of intensity images generated by random matrices with different height pixels through different interpolation algorithms, where FIG. 4A schematically shows a spectrum distribution of an intensity image generated through an NNU interpolation algorithm; FIG. 4B schematically shows a spectrum distribution of an intensity image generated through a BU interpolation algorithm; and FIG. 4C schematically shows a spectrum distribution of an intensity image generated through a BCU interpolation algorithm;

FIG. 5 shows depth distribution statistics of depth images generated through different interpolation algorithms according to an embodiment of the present disclosure;

FIG. 6 is a schematic diagram of a network architecture of a hologram model according to an embodiment of the present disclosure;

FIG. 7 schematically shows functional modules of a hologram model training apparatus based on an unlabeled sample training set according to an embodiment of the present disclosure; and

FIG. 8 is a schematic structural diagram of a computer device according to an embodiment of the present disclosure.

### DETAILED DESCRIPTION OF THE EMBODIMENTS

Firstly, some technical terms involved in the embodiments of the present disclosure are described as follows:

Neural network training is a process of adjusting parameters such as a weight and a bias in a neural network to enable the neural network to accurately extract a feature from input data and perform prediction or classification. This process heavily relies on quality and diversity of a dataset, and building a high-quality three-dimensional holographic dataset often requires significant time, manpower, and financial costs. There are limited datasets directly applicable to the field of three-dimensional holography. A suitable dataset is extremely important for training a network model. In order to approach ultimate performance of a convolutional neural network (CNN) model and achieve a good training result, a training set used for model training should be as rich and comprehensive as possible. However, because the dataset contains limited data and cannot provide all possible training data, a trained network model often achieves better performance on a test set than on a training set. A sample-free dataset in which data is not limited can provide all the possible training data, with a high optimization limit.

A complex amplitude distribution of a diffraction field in a three-dimensional scenario is determined by intensity and depth distributions of the three-dimensional scenario. Different intensity and depth distributions will produce different complex amplitudes. In order to effectively ensure encoding and generalization capabilities of a neural network model, a three-dimensional dataset should cover diverse intensity distributions at all depth levels. Using a fully convolutional neural network to perform pure phase encoding on a complex amplitude, using a sample-free intensity image and a uniformly distributed depth image for training, and flexibly controlling ratios of high-frequency information and low-frequency information in the training set have become a good approach for the neural network to encode a multi-depth hologram.

In view of this, an embodiment of the present disclosure provides a hologram model training method based on an unlabeled sample training set. The hologram model training method utilizes a concept of a sample-free dataset to simulate training data by generating diverse intensity images and uniformly distributed depth images, thereby approaching the ultimate performance of the CNN model. The fully convolutional neural network is used to perform the pure phase encoding on the complex amplitude, and the ratios of the high-frequency information and the low-frequency information in the training set are flexibly controlled. This method not only reduces the costs of building the high-quality three-dimensional holographic dataset, but also improves the encoding and generalization capabilities of the neural network model.

The technical solutions in the embodiments of the present disclosure are clearly and completely described below with reference to the accompanying drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure more obvious and easy to understand, the present disclosure will be further described in detail with reference to the accompanying drawings and specific implementations.

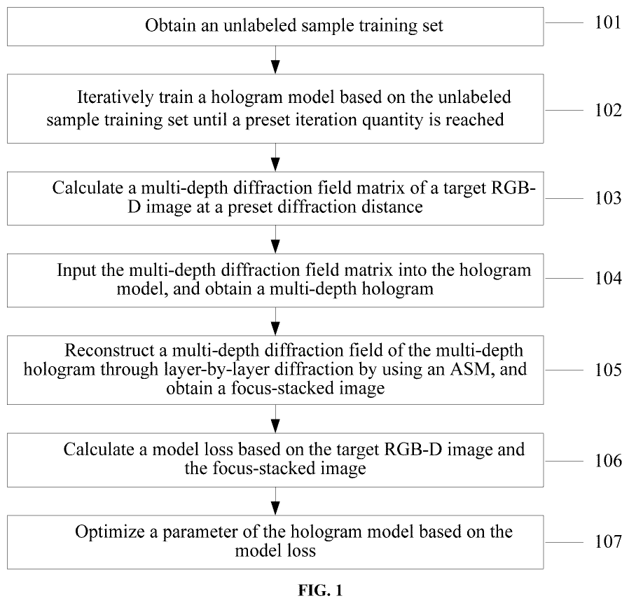

In an exemplary embodiment, as shown in FIG. 1, a hologram model training method based on an unlabeled sample training set is provided, including following steps 101 to 107. Specifically:
Step 101: Obtain an unlabeled sample training set, where the unlabeled sample training set includes a plurality of RGB-D images, the RGB-D image is obtained by combining an intensity image and a depth image, the intensity image contains information of red, green, and blue channels, and the depth image contains information of a distance from an object surface to an observation point.
Step 102: Iteratively train a hologram model based on the unlabeled sample training set until a preset iteration quantity is reached.
Step 103: Calculate a multi-depth diffraction field matrix of a target RGB-D image at a preset diffraction distance, where the target RGB-D image is any RGB-D image in the unlabeled sample training set.
Step 104: Input the multi-depth diffraction field matrix into the hologram model, and obtain a multi-depth hologram.
Step 105: Reconstruct a multi-depth diffraction field of the multi-depth hologram through layer-by-layer diffraction by using an ASM, and obtain a focus-stacked image.
Step 106: Calculate a model loss based on the target RGB-D image and the focus-stacked image.
Step 107: Optimize a parameter of the hologram model based on the model loss.

By performing the above steps 101 to 107, the present disclosure can make full use of unlabeled RGB-D image data, achieve efficient and high-quality hologram generation through iterative training and model parameter optimization, and also reduce a cost of data annotation.

In another exemplary embodiment of the present disclosure, a method for generating the intensity image and the depth image in the step 101 specifically includes following steps:

A row quantity h of a first original matrix and a preset aspect ratio of the intensity image are determined.

The row quantity h of the first original matrix is multiplied by the preset aspect ratio of the intensity image, a rounding operation is performed, and a column quantity w of the first original matrix is obtained.

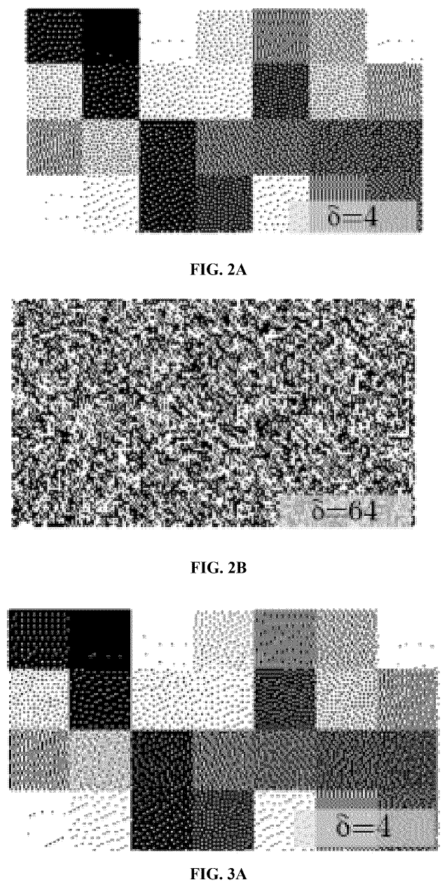

The first original matrix with the row quantity h and the column quantity w is generated, where each element value in the first original matrix is randomly distributed between 0 and 255. As shown in FIGS. 2A-2B, δ represents a height pixel quantity of a matrix. FIG. 2A schematically shows a random matrix with four height pixels; and FIG. 2B schematically shows a random matrix with 64 height pixels.

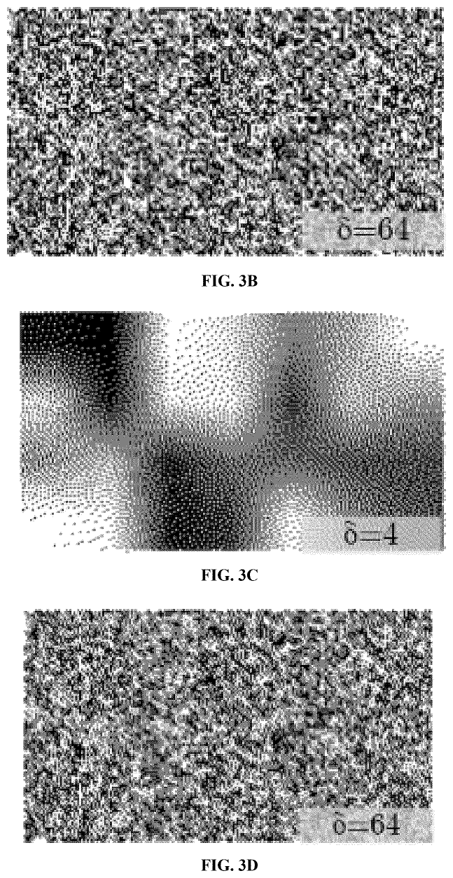

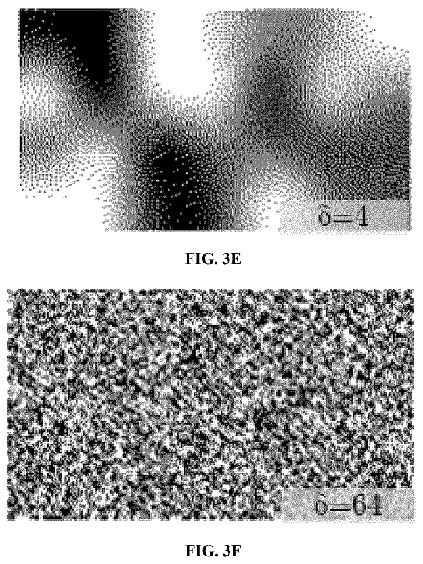

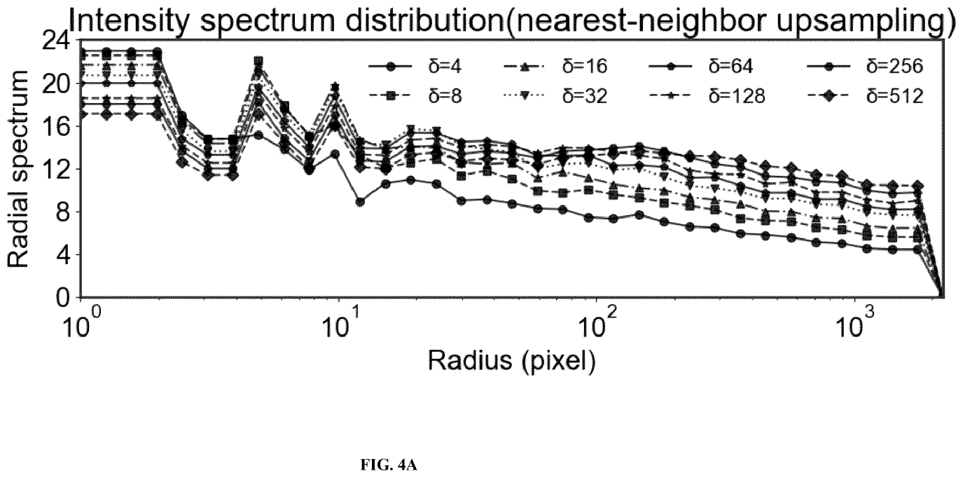

An intensity image with a width w1 and a height h1 is generated based on the first original matrix by using an interpolation algorithm, where the w1 and the h1 satisfy the preset aspect ratio. A plurality of interpolation algorithms can be used, and different interpolation algorithms have different spectrum distributions. Alternatively, different interpolation algorithms may be used together. Intensity images generated based on different height pixel quantities through different interpolation algorithms are shown in FIGS. 3A-3F. FIG. 3A schematically shows an intensity image generated by the random matrix with four height pixels through an NNU interpolation algorithm. FIG. 3B schematically shows an intensity image generated by the random matrix with 64 height pixels through the NNU interpolation algorithm. FIG. 3C schematically shows an intensity image generated by the random matrix with four height pixels through a BU interpolation algorithm. FIG. 3D schematically shows an intensity image generated by the random matrix with 64 height pixels through the BU interpolation algorithm. FIG. 3E schematically shows an intensity image generated by the random matrix with four height pixels through a BCU interpolation algorithm. FIG. 3F schematically shows an intensity image generated by the random matrix with 64 height pixels through the BCU interpolation algorithm. The interpolation algorithm is usually intended to increase resolution or fineness of an image. Through interpolation processing, the intensity image contains more data points or finer information. Pixel quantities (or resolution) in FIG. 3A and FIG. 3B are respectively higher than those in FIG. 2A and FIG. 2B.

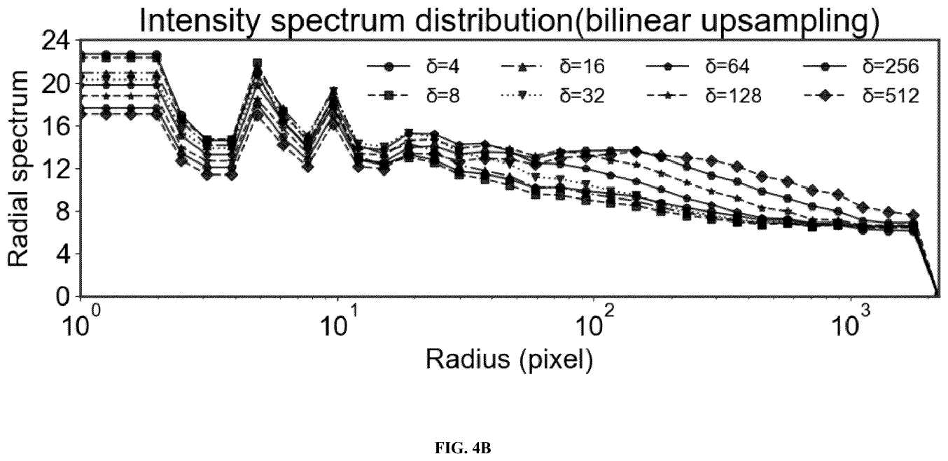

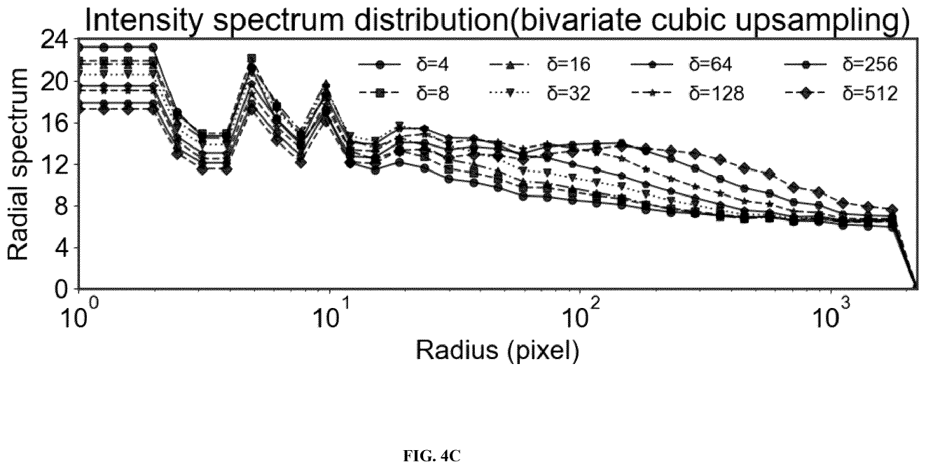

In this implementation, spectrum distributions that are of intensity images obtained based on different height pixel quantities δ through different interpolation algorithms and analyzed through spectrum averaging are shown in FIGS. 4A-4C. FIG. 4A schematically shows spectrum distributions of intensity images generated based on different height pixel quantities through the NNU interpolation algorithm. FIG. 4B schematically shows spectrum distributions of intensity images generated based on different height pixel quantities through the BU interpolation algorithm. FIG. 4C schematically shows spectrum distributions of intensity images generated based on different height pixel quantities through the BCU interpolation algorithm. According to FIGS. 4A-4C, it can be found that different values of the δ and different interpolation algorithms correspond to significantly different spectrum distributions. The spectrum distribution of the intensity image obtained through the NNU interpolation algorithm shows a significant decrease in a low-frequency part and a significant increase in a high-frequency part as the δ increases. A spectrum difference between the intensity images generated through the BU and BCU interpolation algorithms is not significant, but upon careful observation, it can be found that there are slight differences in both low-frequency and high-frequency components. As the δ increases, the spectrum distributions of the intensity images generated through the BU and BCU interpolation algorithms show a decrease in the low-frequency component, which is similar to the spectrum distribution when the NNU interpolation algorithm is used, and shows an increase in the high-frequency component, which is inconsistent with the spectrum distribution when the NNU interpolation algorithm is used. Therefore, parameter control can achieve a specific spectrum distribution of the intensity image and a uniform distribution of the depth image.

A row quantity h2 and a column quantity w2 of a second original matrix are determined, where the h2 is less than or equal to the h1, and the w2 is less than or equal to the w1.

The second original matrix with the row quantity h2 and the column quantity w2 is generated, where each element value in the second original matrix is randomly distributed between 0 and 255.

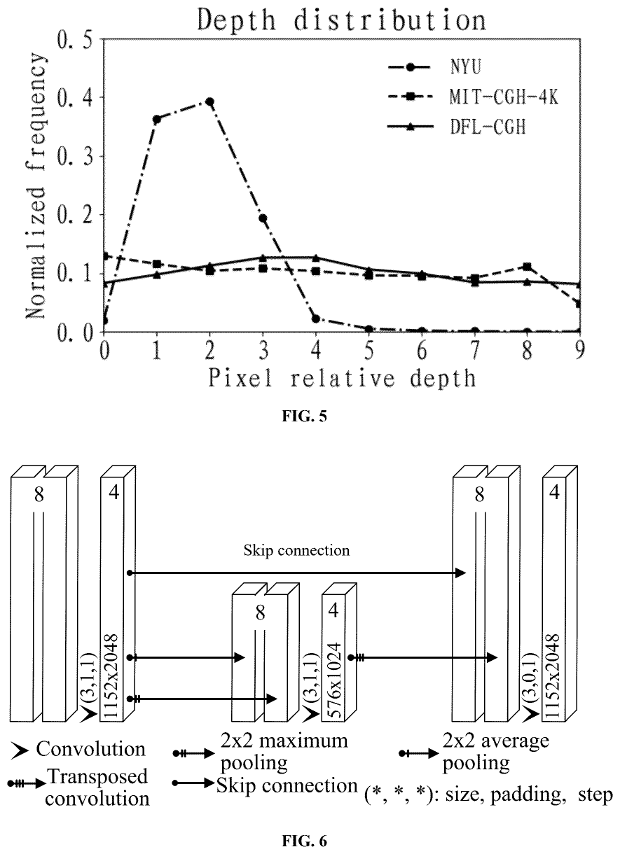

A depth image with the width w1 and the height h1 is generated based on the second original matrix by using the interpolation algorithm. A plurality of interpolation algorithms can be used, and different interpolation algorithms have different spectrum distributions. Alternatively, different interpolation algorithms may be used together to obtain the depth image. A depth distribution of the depth image is shown in FIG. 5. According to FIG. 5, it can be seen that compared with an NYU dataset and a three-dimensional modeling dataset MIT-CGH-4K that are collected by a depth camera, the unlabeled sample training set ZS-CGH has a more uniform distribution in ten depth layers.

As an optional implementation, the row quantity h of the first original matrix is determined based on a frequency. It is recommended to set the row quantity h to 1 to 16 for a low frequency, 16 to 64 for a medium frequency, and higher than 64 for a high frequency.

In another exemplary embodiment of the present disclosure, the calculating a multi-depth diffraction field matrix of a target RGB-D image at a preset diffraction distance in the step 103 specifically includes:
uniformly dividing the target RGB-D image into N depth layers based on a depth, calculating a complex amplitude distribution of each depth layer by using the ASM, and obtaining the multi-depth diffraction field matrix of the target RGB-D image, where Nis an integer, and each depth layer has an equal depth spacing. Iteration of a multi-depth diffraction process based on the ASM can be extended to a more general scenario without sacrificing generality.

A calculation formula for the complex amplitude distribution is as follows:

Uₙ(x,y)=∧{Uₙ₋₁(x,y)}Δz′=\sqrt{I(x,y)}□exp[jφ₀]□Mₙ(x,y)+ASM{Uₙ₋₁(x,y)}□_{Δz}′□[1−Mₙ(x,y)]ASM{Uₙ₋₁(x,y)}Δz′=F⁻¹{F{Uₙ₋₁(x,y)}□H_{ΔZ′}(fₓ,f_{y})}H_{Δz′}(fₓ,f_{y})=exp[jkΔz′\sqrt{1−(λfₓ)²−(λf_{y})²}].

In the above formulas, n represents an n^{th} depth layer of the target RGB-D image, where n=[0, N−1], and N represents a total quantity of depth layers; Uₙ(x, y) represents a complex amplitude distribution of the target RGB-D image at a point (x, y) in the n^{th} depth layer; ∧(□) represents a symbol representation of an angular spectrum diffraction process, and is used to represent a process of propagating a light wave from a current depth layer to a next depth layer in the target RGB-D image; Δz′ represents the preset diffraction distance; I(x, y) represents an amplitude of the target RGB-D image at the point (x, y); j represents an imaginary unit, where j²=−1; φ₀ represents an initial fluctuation state of the light wave; Mₙ(x, y) represents a Boolean mask of the target RGB-D image at the point (x, y) in the n^{th} depth layer, and is used to distinguish light wave distributions in different depth layers; ASM { . . . } Δz′ represents a process of calculating the preset diffraction distance by using the ASM, and is used to calculate a complex amplitude distribution of the light wave after propagation in free space; FU) represents a symbol representation of Fourier transform, and is used to convert a spatial domain signal into a frequency domain signal; F⁻¹{ } represents a symbol representation of inverse Fourier transform, and is used to convert the frequency domain signal into the spatial domain signal; H_{Δz′}(fₓ, f_{y}) represents a transfer function, indicating a phase change of the light wave during the propagation in the free space, where fₓ and f_{y} respectively represent spatial frequency components in x and y directions; and k represents a wave number, where k=2 π/λ, and λ represents a wavelength of the light wave,

$$\vert {f}_{x} \vert , \vert {f}_{y} \vert < \frac{1}{2} Δ p ,$$

where ΔP represents a pixel spacing of an SLM. After layer-by-layer calculation, a complex amplitude Uₕ(x, y) of a holographic plane Sₕ can be obtained. With the help of the hologram model constructed by a CNN, the complex amplitude Uₕ(x, y) will be used to encode the multi-depth hologram.

In another exemplary embodiment of the present disclosure, the step 104 specifically includes:
performing format conversion on a multi-depth diffraction field of the target RGB-D image, and obtaining a multi-channel input matrix; and
inputting the multi-channel input matrix into the hologram model, and obtaining the multi-depth hologram, where the hologram model includes an input layer and an output layer, the input layer is configured to extract a feature from the multi-channel input matrix to generate a phase matrix, and input the phase matrix into the output layer, and the output layer is configured to reconstruct the phase matrix based on a phase reconstruction algorithm and obtain the multi-depth hologram.

As an optional implementation, the performing format conversion on a multi-depth diffraction field of the target RGB-D image, and obtaining a multi-channel input matrix specifically includes:
calculating a complex amplitude distribution of the target RGB-D image from an (N−1)^{th} depth layer to a holographic plane according to a following formula:

Uₕ(x,y)=ASM{U_{N-1}(x,y)}_{-zh′-(N-1)Δz′}.
where Uₕ(x, y) represents a complex amplitude distribution of the holographic plane at a point (x, y); ASM { . . . }Δz′ represents the process of calculating the preset diffraction distance by using the ASM, and is used to calculate the complex amplitude distribution of the light wave after the propagation in the free space; U_{N-1}(x, y) represents a complex amplitude distribution of the target RGB-D image at a point (x, y) in an (N−1)^{th} depth layer, where N represents the total quantity of depth layers; and −zh′−(N−1) represents a reverse distance from the (N−1)^{th} depth layer to the holographic plane;
converting the Uₕ(x, y) into real part channel data and imaginary part channel data according to an Euler's formula; and
performing a shuffle operation based on the real part channel data and the imaginary part channel data to generate a multi-channel input matrix containing eight channels.

In another exemplary embodiment of the present disclosure, a calculation formula in the step 105 is specifically as follows:

$$R ( x , y ) = {\sum }_{n = 0}^{N - 1} {R}_{n} ( x , y ) .$$

Rₙ(x, y)=ASM{U_{H}(x, y)}_{z=z}_{ₕ}_{+nΔz} □Mₙ(x, y).

ASM{U_{H}(x, y)}_{z=z}_{ₕ}_{+nΔz}=F⁻¹{F{U_{H}(x, y)}□H_{z=z}_{ₕ}_{+nΔz} (fₓ, f_{y})}.

In the above formulas, R(x, y) represents a pixel value of a focus-stacked image at a point (x, y) in the multi-depth hologram; Rₙ(x, y) represents a focused light field at a point (x, y) in an n^{th} depth layer in the multi-depth hologram; n represents the n^{th} depth layer of the target RGB-D image, where n=[0, N−1], and N represents the total quantity of depth layers; U_{H}(x, y) represents a complex amplitude at the point (x, y) in the multi-depth hologram; Mₙ(x, y) represents the Boolean mask of the target RGB-D image at the point (x, y) in the n^{th} depth layer, and is used to distinguish the light wave distributions in the different depth layers; ASM { . . . } z represents calculation of a diffraction field of the multi-depth hologram at a reproduction distance, where z represents the reproduction distance, Zh represents a reproduction distance of an initial focal plane, and Δz represents a spacing between adjacent focal planes; F{ } represents the symbol representation of the Fourier transform, and is used to convert the spatial domain signal into the frequency domain signal; F⁻¹{ } represents the symbol representation of the inverse Fourier transform, and is used to convert the frequency domain signal into the spatial domain signal; Hz represents the transfer function, where zₕ represents the reproduction distance of the initial focal plane, and Δz represents the spacing between the adjacent focal planes; and fₓ Az f_{y} respectively represent the spatial frequency components in the x and y directions.

In another exemplary embodiment of the present disclosure, a formula for calculating the model loss based on the target RGB-D image and the focus-stacked image in the step 106 is specifically as follows:

$$Loss = {L}_{1} \{ \sqrt{I ( x , y )} , \frac{\sum \sum \sqrt{I ( x , y )}}{\sum \sum R ( x , y )} ▯ R ( x , y ) \} .$$

In the above formula, Loss represents a loss of a current iteration; L1{ } represents a mean absolute error loss function; I(x, y) represents the amplitude of the target RGB-D image at the point (x, y); and R(x, y) represents the pixel value of the focus-stacked image at the point (x, y) in the multi-depth hologram.

$$\frac{\sum \sum \sqrt{I ( x , y )}}{\sum \sum R ( x , y )}$$

represents linear transform, which is intended to match brightness of a target intensity image. Laser power is adjusted, which can be achieved in an optical experiment.

As an optional implementation, as shown in FIG. 6, a CNN-based fully convolutional neural network is designed to encode a hologram model of a pure phase hologram.

An input of the CNN is generated from the obtained complex amplitude Uₕ(x, y) For the convenience of holographic phase encoding, the Euler's formula is used to convert the complex amplitude into two channels representing real and imaginary parts. A “shuffle” operation is performed to improve model efficiency and generalization capability. This operation is applied to data from the two channels to generate eight channels. This conversion produces a 1152*2048*8 matrix as the input of the CNN.

An output of the CNN is constituted by a 1152*2048*4 phase matrix. A phase reconstruction technology is used to obtain the multi-depth hologram from a U-Net+ output.

A loss function of the CNN is an L1 (mean absolute error) loss function. The method in the step 105 is used for holographic reproduction, and a superimposed reconstructed focus-stacked image R(x, y) is generated. A residual (calculated as a difference between an amplitude of the input RGB intensity image and an amplitude \sqrt{I(x, y)} of the superimposed reconstructed focus-stacked image) is used as the loss function, which helps update the parameter of the hologram model. The CNN consists of three convolutional modules, two 2*2 maximum pooling downsampling modules whose convolution kernels (a size, a padding, and a stride) are set to (3, 1, 1), and two (2, 0, 4) transposed convolution upsampling modules. Convolutional modules of a same size on left and right sides are connected through a skip connection to facilitate transfer of a feature map.

An intensity residual of an input RGB-D image is used as the loss function. Based on the CNN model, the parameter of the hologram model is adjusted through gradient descent backpropagation to optimize quality of encoding the pure phase hologram by the CNN model.

The present disclosure also provides an application scenario. The above hologram model training method based on an unlabeled sample training set is applied to the application scenario. Specifically, the hologram model training method based on an unlabeled sample training set provided in the embodiments can be applied to a digital reconstruction scenario for a three-dimensional object. The digital reconstruction scenario for the three-dimensional object includes a data collection stage, a model training and processing link, and a reconstruction output stage. Data enters the model training and processing link from the data collection stage and undergoes iterative training and optimization of a hologram model trained based on an unlabeled sample, to generate a precise hologram model that is subsequently used in the downstream reconstruction output stage. The hologram model training method based on an unlabeled sample training set provided in the embodiments belongs to the iterative training and optimization of the hologram model in the model training and processing link. Specifically, during digital reconstruction processing for the three-dimensional object, the hologram model can be iteratively trained based on an unlabeled RGB-D image dataset, and the parameter of the hologram model can be continuously optimized to improve prediction and reconstruction capabilities of the multi-depth diffraction field, thereby ultimately achieving high-precision digital reconstruction of the three-dimensional object.

Compared with a traditional hologram generation method based on the neural network, the present disclosure has following advantages:

1. The unlabeled sample training set based on the present disclosure is generated in real time through numerical calculation software, without occupying additional storage space, and is used to replace a real scenario training set in a model training process to train the fully convolutional neural network in a simple and flexible “zero-sample” way. A row quantity of random data and an interpolation method are adjusted, such that the ratios of the high-frequency information and the low-frequency information of the intensity image in the training set can be controlled, and the depth image can be uniformly distributed in different depth layers to adapt to practical application scenarios. An experimental result shows that numerical and full-color optical reconstruction effects of the hologram model are validated based on a real scenario and a test pattern. Performance of a model trained based on the ZS-CGH far exceeds that of a model trained based on the NYU dataset collected by the depth camera in various scenarios, is about the same as that of a model trained based on the carefully designed three-dimensional modeling dataset MIT-CGH-4K in a more realistic scenario, and even exceeds that of a model trained based on the three-dimensional modeling dataset in a binary scenario.

2. Realistic display quality and excellent three-dimensional depth focusing effect. The present disclosure achieves excellent performance in holographic display by utilizing the CNN. The experimental result shows that the trained hologram model exhibits the realistic display quality and the excellent three-dimensional depth focusing effect in a plurality of test sets (including a real scenario test set and a binary pattern test set). Compared with a traditional method, the CNN has a stronger encoding capability to better capture depth information, making the holographic display more realistic and accurate visually.

3. Enhanced generalization capability and stability of the hologram model. The present disclosure enhances a generalization capability of a holographic encoding neural network by geometrically modeling an intensity image and a uniformly distributed depth image in a complex scenario, such that the holographic encoding neural network exhibits high stability and reliability even when facing new or unseen data. Unlike the traditional method, the newly designed dataset optimizes an intensity spectrum and a depth distribution, such that the hologram model can better handle the complex scenario, thereby enhance adaptability of the hologram model in a real scenario.

4. High encoding speed and superior performance. The experiment shows that the present disclosure achieves encoding time of only 10 ms under 4K resolution, and also achieves an average peak signal-to-noise ratio (PSNR) of 35.55 dB and a structural similarity (SSIM) of 0.87 on the real scenario test set. Although there is a difference between the ZS-CGH and the MIT-CGH-4K, a difference between reconstruction effects based on the ZS-CGH and the MIT-CGH-4K is negligible, indicating that the holographic encoding method in the present disclosure has excellent performance and application potential. This provides a new technological path for implementing real-time high-quality holographic display, and significantly improves encoding efficiency and display quality.

5. A smoother phase can be generated. Compared with the traditional method, the hologram generated by the CNN-based hologram model has a gentler phase change, and avoids an abrupt phase change and other problems. In this way, circles in an image reproduced by the DPH algorithm and speckle noise in an image reproduced by the WH algorithm are avoided.

Based on the same inventive concept, the embodiments of the present disclosure further provide a hologram model training apparatus based on an unlabeled sample training set to implement the above hologram model training method based on an unlabeled sample training set. A problem-solving implementation solution provided by the hologram model training apparatus is similar to the implementation solution described in the above method. Therefore, for following specific limitations on one or more embodiments of the hologram model training apparatus based on an unlabeled sample training set, reference may be made to the above limitations on the hologram model training method based on an unlabeled sample training set, and details are not described herein again.

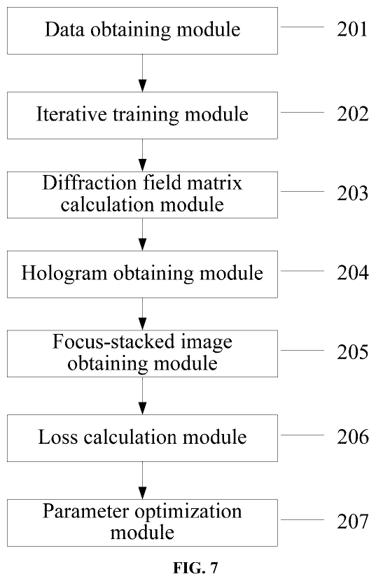

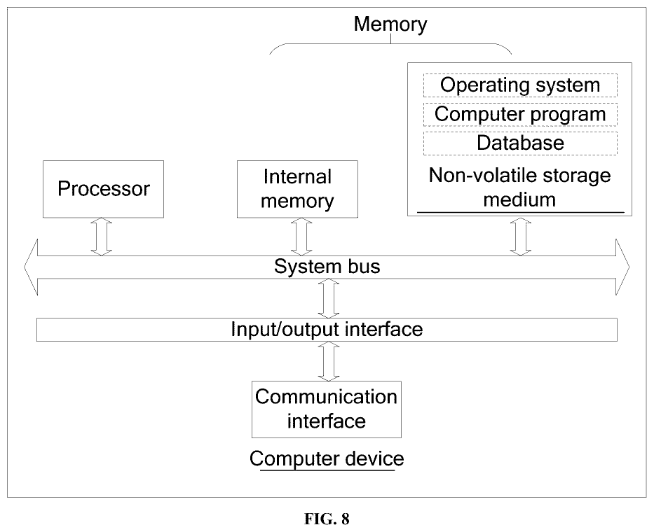

In an exemplary embodiment, as shown in FIG. 7, a hologram model training apparatus based on an unlabeled sample training set is provided, including:
a data obtaining module 201 configured to obtain an unlabeled sample training set, where the unlabeled sample training set includes a plurality of RGB-D images, the RGB-D image is obtained by combining an intensity image and a depth image, the intensity image contains information of red, green, and blue channels, and the depth image contains information of a distance from an object surface to an observation point;
an iterative training module 202 configured to iteratively train a hologram model based on the unlabeled sample training set until a preset iteration quantity is reached;
a diffraction field matrix calculation module 203 configured to calculate a multi-depth diffraction field matrix of a target RGB-D image at a preset diffraction distance, where the target RGB-D image is any RGB-D image in the unlabeled sample training set;
a hologram obtaining module 204 configured to input the multi-depth diffraction field matrix into the hologram model, and obtain a multi-depth hologram;
a focus-stacked image obtaining module 205 configured to reconstruct a multi-depth diffraction field of the multi-depth hologram through layer-by-layer diffraction by using an ASM, and obtain a focus-stacked image;
a loss calculation module 206 configured to calculate a model loss based on the target RGB-D image and the focus-stacked image; and
a parameter optimization module 207 configured to optimize a parameter of the hologram model based on the model loss.

In an exemplary embodiment, a computer device is provided. The computer device may be a server or a terminal, and an internal structure thereof may be as shown in FIG. 8. The computer device includes a processor, a memory, an input/output (I/O) interface, and a communication interface. The processor, the memory, and the I/O interface are connected through a system bus, and the communication interface is connected to the system bus through the I/O interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for running the operating system and the computer program in the non-volatile storage medium. The database of the computer device is configured to store unlabeled sample training data. The I/O interface of the computer device is configured to exchange information between the processor and an external device. The communication interface of the computer device is configured to communicate with an external terminal through a network. The computer program is executed by the processor to implement a hologram model training method based on an unlabeled sample training set.

Those skilled in the art may understand that the structure shown in FIG. 8 is only a block diagram of a partial structure related to the solutions of the present disclosure and does not constitute a limitation on the computer device to which the solutions of the present disclosure are applied. Specifically, the computer device may include more or less components than those shown in the figure, or combine some components, or have different component arrangements. In an exemplary embodiment, a computer device is provided, including a memory and a processor. The memory stores a computer program, and the computer program is executed by the processor to implement the steps in the above method embodiments.

In an exemplary embodiment, a computer-readable storage medium is provided. The computer-readable storage medium stores a computer program, and the computer program is executed by a processor to implement the steps of the above method embodiments.

In an exemplary embodiment, a computer program product is provided, including a computer program. The computer program is executed by a processor to implement the steps of the above method embodiments.

It should be noted that information of a user (including but not limited to device information of the user, personal information of the user, and the like) and data (including but not limited to data for analysis, stored data, displayed data, and the like) in the present disclosure are information and data authorized by the user or fully authorized by each party, and relevant data shall be collected, used and processed according to relevant regulations.

Those of ordinary skill in the art may understand that all or some of the procedures in the method of the foregoing embodiments may be implemented by a computer program instructing related hardware. The computer program may be stored in a non-volatile computer-readable storage medium. When the computer program is executed, the procedures in the embodiments of the above method may be performed. Any reference to a memory, a database, or other media used in the embodiments of the present disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of the present disclosure may include at least one of a relational database and a non-relational database. The non-relational database may include a blockchain-based distributed database, but is not limited thereto. The processor in the embodiments of the present disclosure may be a general processor, a central processing unit, a graphics processor, a digital signal processor, a programmable logic device, and a data processing logic device based on quantum computing, but is not limited thereto.

The technical characteristics of the above embodiments can be employed in arbitrary combinations. For brevity of description, all possible combinations of all the technical characteristics of the above embodiments may not be described; however, these combinations of the technical characteristics should be construed as falling within the scope defined by this specification as long as no contradiction occurs.

Several examples are used herein for illustration of the principles and implementations of the present disclosure. The description of the foregoing embodiments is used to help illustrate the method of the present disclosure and the core principles thereof. In addition, those of ordinary skill in the art can make various modifications in terms of specific implementations and scope of application in accordance with the teachings of the present disclosure. In conclusion, the content of the present specification shall not be construed as a limitation to the present disclosure.

What is claimed is:

1. A hologram model training method based on an unlabeled sample training set, comprising:
obtaining an unlabeled sample training set, wherein the unlabeled sample training set comprises a plurality of red/green/blue-depth (RGB-D) images, the RGB-D image is obtained by combining an intensity image and a depth image, the intensity image contains information of red, green, and blue channels, and the depth image contains information of a distance from an object surface to an observation point;
iteratively training a hologram model based on the unlabeled sample training set until a preset iteration quantity is reached:
calculating a multi-depth diffraction field matrix of a target RGB-D image at a preset diffraction distance, wherein the target RGB-D image is any RGB-D image in the unlabeled sample training set;
inputting the multi-depth diffraction field matrix into the hologram model, and obtaining a multi-depth hologram;
reconstructing a multi-depth diffraction field of the multi-depth hologram through layer-by-layer diffraction by using an angular spectrum method (ASM), and obtaining a focus-stacked image;
calculating a model loss based on the target RGB-D image and the focus-stacked image; and
optimizing a parameter of the hologram model based on the model loss.

2. The hologram model training method based on an unlabeled sample training set according to claim 1, wherein a method for generating the intensity image and the depth image specifically comprises:
determining a row quantity h of a first original matrix and a preset aspect ratio of the intensity image;
multiplying the row quantity h of the first original matrix by the preset aspect ratio of the intensity image, performing a rounding operation, and obtaining a column quantity w of the first original matrix;
generating the first original matrix with the row quantity h and the column quantity w, wherein each element value in the first original matrix is randomly distributed between 0 and 255;
generating an intensity image with a width w1 and a height h1 based on the first original matrix by using an interpolation algorithm, wherein the w1 and the h1 satisfy the preset aspect ratio;
determining a row quantity h2 and a column quantity w2 of a second original matrix, wherein the h2 is less than or equal to the h1, and the w2 is less than or equal to the w1;
generating the second original matrix with the row quantity h2 and the column quantity w2, wherein each element value in the second original matrix is randomly distributed between 0 and 255; and
generating a depth image with the width w1 and the height h1 based on the second original matrix by using the interpolation algorithm.

3. The hologram model training method based on an unlabeled sample training set according to claim 1, wherein the calculating a multi-depth diffraction field matrix of a target RGB-D image at a preset diffraction distance specifically comprises:
uniformly dividing the target RGB-D image into N depth layers based on a depth, calculating a complex amplitude distribution of each depth layer by using the ASM, and obtaining the multi-depth diffraction field matrix of the target RGB-D image, wherein N is an integer, and each depth layer has an equal depth spacing, wherein
a calculation formula for the complex amplitude distribution is as follows:
Uₙ(x,y)=∧{Uₙ₋₁(x,y)}Δz′=\sqrt{I(x,y)}□exp[jφ₀]□Mₙ(x,y)+ASM{Uₙ₋₁(x,y)}□_{Δz}′□[1−Mₙ(x,y)]ASM{Uₙ₋₁(x,y)}Δz′=F⁻¹{F{Uₙ₋₁(x,y)}□H_{ΔZ′}(fₓ,f_{y})}H_{Δz′}(fₓ,f_{y})=exp[jkΔz′\sqrt{1−(λfₓ)²−(λf_{y})²}];
wherein n represents an n^{th} depth layer of the target RGB-D image, wherein n=[0, N−1], and N represents a total quantity of depth layers; Uₙ(x, y) represents a complex amplitude distribution of the target RGB-D image at a point (x, y) in the n^{th} depth layer; ∧{□} represents a symbol representation of an angular spectrum diffraction process, and is used to represent a process of propagating a light wave from a current depth layer to a next depth layer in the target RGB-D image; Δz′ represents the preset diffraction distance; I(x, y) represents an amplitude of the target RGB-D image at the point (x, y); j represents an imaginary unit, wherein, j²=−1; φ₀ represents an initial fluctuation state of the light wave; Mₙ(x, y) represents a Boolean mask of the target RGB-D image at the point (x, y) in the n^{th} depth layer, and is used to distinguish light wave distributions in different depth layers; ASM { . . . } Δz′ represents a process of calculating the preset diffraction distance by using the ASM, and is used to calculate a complex amplitude distribution of the light wave after propagation in free space; F{ } represents a symbol representation of Fourier transform, and is used to convert a spatial domain signal into a frequency domain signal; F⁻¹{ } represents a symbol representation of inverse Fourier transform, and is used to convert the frequency domain signal into the spatial domain signal; H_{Δz′}(fₓ, f_{y}) represents a transfer function, indicating a phase change of the light wave during the propagation in the free space, wherein fₓ and f_{y} respectively represent spatial frequency components in x and y directions; and k represents a wave number, wherein k=2 π/λ, and λ represents a wavelength of the light wave.

4. The hologram model training method based on an unlabeled sample training set according to claim 1, wherein the inputting the multi-depth diffraction field matrix into the hologram model, and obtaining a multi-depth hologram specifically comprises:
performing format conversion on a multi-depth diffraction field of the target RGB-D image, and obtaining a multi-channel input matrix; and
inputting the multi-channel input matrix into the hologram model, and obtaining the multi-depth hologram, wherein the hologram model comprises an input layer and an output layer, the input layer is configured to extract a feature from the multi-channel input matrix to generate a phase matrix, and input the phase matrix into the output layer, and the output layer is configured to reconstruct the phase matrix based on a phase reconstruction algorithm and obtain the multi-depth hologram.

5. The hologram model training method based on an unlabeled sample training set according to claim 1, wherein the performing format conversion on a multi-depth diffraction field of the target RGB-D image, and obtaining a multi-channel input matrix specifically comprises:
calculating a complex amplitude distribution of the target RGB-D image from an (N−1)^{th} depth layer to a holographic plane according to a following formula:
Uₕ(x,y)=ASM{U_{N-1}(x,y)}_{-zh′-(N-1)Δz′};
wherein Uₕ(x, y) represents a complex amplitude distribution of the holographic plane at a point (x, y); ASM { . . . }Δz′ represents a process of calculating the preset diffraction distance by using the ASM, and is used to calculate a complex amplitude distribution of a light wave after propagation in free space; U_{N-1}(x, y) represents a complex amplitude distribution of the target RGB-D image at a point (x, y) in the (N−1)^{th} depth layer, wherein N represents a total quantity of depth layers; and −zh′−(N−1) represents a reverse distance from the (N−1)^{th} depth layer to the holographic plane;
converting the Uₕ(x, y) into real part channel data and imaginary part channel data according to an Euler's formula; and
performing a shuffle operation based on the real part channel data and the imaginary part channel data to generate a multi-channel input matrix containing eight channels.

6. The hologram model training method based on an unlabeled sample training set according to claim 1, wherein a calculation formula for reconstructing the multi-depth diffraction field of the multi-depth hologram through the layer-by-layer diffraction by using the ASM, and obtaining the focus-stacked image is specifically as follows:
$$R ( x , y ) = {\sum }_{n = 0}^{N - 1} {R}_{n} ( x , y ) ;$$
Rₙ(x, y)=ASM{U_{H}(x, y)}_{z=z}_{ₕ}_{+nΔz} □Mₙ(x, y);
ASM{U_{H}(x, y)}_{z=z}_{ₕ}_{+nΔz}=F⁻¹{F{U_{H}(x, y)}□H_{z=z}_{ₕ}_{+nΔz} (fₓ, f_{y})};
wherein R(x, y) represents a pixel value of a focus-stacked image at a point (x, y) in the multi-depth hologram; Rₙ(x, y) represents a focused light field at a point (x, y) in an n^{th} depth layer in the multi-depth hologram; n represents the n^{th} depth layer of the target RGB-D image, wherein n=[0, N−1], and N represents a total quantity of depth layers; U_{H}(x, y) represents a complex amplitude at the point (x, y) in the multi-depth hologram; Mₙ(x, y) represents a Boolean mask of the target RGB-D image at the point (x, y) in the n^{th} depth layer, and is used to distinguish light wave distributions in different depth layers; ASM { . . . } z represents calculation of a diffraction field of the multi-depth hologram at a reproduction distance, wherein z represents the reproduction distance, Zh represents a reproduction distance of an initial focal plane, and Δz represents a spacing between adjacent focal planes; F{ } represents a symbol representation of Fourier transform, and is used to convert a spatial domain signal into a frequency domain signal; F⁻¹{ } represents a symbol representation of inverse Fourier transform, and is used to convert the frequency domain signal into the spatial domain signal; Hz represents a transfer function, wherein Zh represents the reproduction distance of the initial focal plane, and Δz represents the spacing between the adjacent focal planes; and fₓ and f_{y} respectively represent spatial frequency components in x and y directions.

7. The hologram model training method based on an unlabeled sample training set according to claim 1, wherein a formula for calculating the model loss based on the target RGB-D image and the focus-stacked image is specifically as follows:
$$Loss = {L}_{1} \{ \sqrt{I ( x , y )} , \frac{\sum \sum \sqrt{I ( x , y )}}{\sum \sum R ( x , y )} ▯ R ( x , y ) \} ;$$
wherein Loss represents a loss of a current iteration; L1{ } represents a mean absolute error loss function; I(x, y) represents an amplitude of the target RGB-D image at a point (x, y); and R(x, y) represents a pixel value of a focus-stacked image at a point (x, y) in the multi-depth hologram.

8. A hologram model training apparatus based on an unlabeled sample training set, wherein the hologram model training apparatus based on an unlabeled sample training set applies the hologram model training method based on an unlabeled sample training set according to claim 1, and the hologram model training apparatus based on an unlabeled sample training set comprises:
a data obtaining module configured to obtain an unlabeled sample training set, wherein the unlabeled sample training set comprises a plurality of RGB-D images, the RGB-D image is obtained by combining an intensity image and a depth image, the intensity image contains information of red, green, and blue channels, and the depth image contains information of a distance from an object surface to an observation point;
an iterative training module configured to iteratively train a hologram model based on the unlabeled sample training set until a preset iteration quantity is reached:
a diffraction field matrix calculation module configured to calculate a multi-depth diffraction field matrix of a target RGB-D image at a preset diffraction distance, wherein the target RGB-D image is any RGB-D image in the unlabeled sample training set;
a hologram obtaining module configured to input the multi-depth diffraction field matrix into the hologram model, and obtain a multi-depth hologram;
a focus-stacked image obtaining module configured to reconstruct a multi-depth diffraction field of the multi-depth hologram through layer-by-layer diffraction by using an ASM, and obtain a focus-stacked image;
a loss calculation module configured to calculate a model loss based on the target RGB-D image and the focus-stacked image; and
a parameter optimization module configured to optimize a parameter of the hologram model based on the model loss.

9. A computer device, comprising: a memory, a processor, and a computer program stored in the memory and executable on the processor, wherein the processor executes the computer program to implement the hologram model training method based on an unlabeled sample training set according to claim 1.

10. A non-transitory computer-readable storage medium, storing a computer program thereon, wherein the computer program is executed by a processor to implement the hologram model training method based on an unlabeled sample training set according to claim 1.

11. The hologram model training apparatus based on an unlabeled sample training set according to claim 8, wherein a method for generating the intensity image and the depth image specifically comprises:
determining a row quantity h of a first original matrix and a preset aspect ratio of the intensity image;
multiplying the row quantity h of the first original matrix by the preset aspect ratio of the intensity image, performing a rounding operation, and obtaining a column quantity w of the first original matrix;
generating the first original matrix with the row quantity h and the column quantity w, wherein each element value in the first original matrix is randomly distributed between 0 and 255;
generating an intensity image with a width w1 and a height h1 based on the first original matrix by using an interpolation algorithm, wherein the w1 and the h1 satisfy the preset aspect ratio;
determining a row quantity h2 and a column quantity w2 of a second original matrix, wherein the h2 is less than or equal to the h1, and the w2 is less than or equal to the w1;
generating the second original matrix with the row quantity h2 and the column quantity w2, wherein each element value in the second original matrix is randomly distributed between 0 and 255; and
generating a depth image with the width w1 and the height h1 based on the second original matrix by using the interpolation algorithm.

12. The hologram model training apparatus based on an unlabeled sample training set according to claim 8, wherein the calculating a multi-depth diffraction field matrix of a target RGB-D image at a preset diffraction distance specifically comprises:
uniformly dividing the target RGB-D image into N depth layers based on a depth, calculating a complex amplitude distribution of each depth layer by using the ASM, and obtaining the multi-depth diffraction field matrix of the target RGB-D image, wherein Nis an integer, and each depth layer has an equal depth spacing, wherein
a calculation formula for the complex amplitude distribution is as follows:
Uₙ(x,y)=∧{Uₙ₋₁(x,y)}Δz′=\sqrt{I(x,y)}□exp[jφ₀]□Mₙ(x,y)+ASM{Uₙ₋₁(x,y)}□_{Δz}′□[1−Mₙ(x,y)]ASM{Uₙ₋₁(x,y)}Δz′=F⁻¹{F{Uₙ₋₁(x,y)}□H_{ΔZ′}(fₓ,f_{y})}H_{Δz′}(fₓ,f_{y})=exp[jkΔz′\sqrt{1−(λfₓ)²−(λf_{y})²}];
wherein n represents an n^{th} depth layer of the target RGB-D image, wherein n=[0, N−1], and N represents a total quantity of depth layers; Uₙ(x, y) represents a complex amplitude distribution of the target RGB-D image at a point (x, y) in the n^{th} depth layer; ∧{□} represents a symbol representation of an angular spectrum diffraction process, and is used to represent a process of propagating a light wave from a current depth layer to a next depth layer in the target RGB-D image; Δz′ represents the preset diffraction distance; I(x, y) represents an amplitude of the target RGB-D image at the point (x, y); j represents an imaginary unit, wherein, j²=−1; φ₀ represents an initial fluctuation state of the light wave; Mₙ(x, y) represents a Boolean mask of the target RGB-D image at the point (x, y) in the n^{th} depth layer, and is used to distinguish light wave distributions in different depth layers; ASM { . . . }Δz′ represents a process of calculating the preset diffraction distance by using the ASM, and is used to calculate a complex amplitude distribution of the light wave after propagation in free space; F{ } represents a symbol representation of Fourier transform, and is used to convert a spatial domain signal into a frequency domain signal; F⁻¹{ } represents a symbol representation of inverse Fourier transform, and is used to convert the frequency domain signal into the spatial domain signal; H_{Δz′}(fₓ, f_{y}) represents a transfer function, indicating a phase change of the light wave during the propagation in the free space, wherein fₓ and f_{y} respectively represent spatial frequency components in x and y directions; and k represents a wave number, wherein k=2 π/λ, and λ represents a wavelength of the light wave.

13. The hologram model training apparatus based on an unlabeled sample training set according to claim 8, wherein the inputting the multi-depth diffraction field matrix into the hologram model, and obtaining a multi-depth hologram specifically comprises:
performing format conversion on a multi-depth diffraction field of the target RGB-D image, and obtaining a multi-channel input matrix; and
inputting the multi-channel input matrix into the hologram model, and obtaining the multi-depth hologram, wherein the hologram model comprises an input layer and an output layer, the input layer is configured to extract a feature from the multi-channel input matrix to generate a phase matrix, and input the phase matrix into the output layer, and the output layer is configured to reconstruct the phase matrix based on a phase reconstruction algorithm and obtain the multi-depth hologram.

14. The hologram model training apparatus based on an unlabeled sample training set according to claim 8, wherein the performing format conversion on a multi-depth diffraction field of the target RGB-D image, and obtaining a multi-channel input matrix specifically comprises:
calculating a complex amplitude distribution of the target RGB-D image from an (N−1)^{th} depth layer to a holographic plane according to a following formula:
Uₕ(x,y)=ASM{U_{N-1}(x,y)}_{-zh′-(N-1)Δz′};
wherein Uₕ(x, y) represents a complex amplitude distribution of the holographic plane at a point (x, y); ASM { . . . }Δz′ represents a process of calculating the preset diffraction distance by using the ASM, and is used to calculate a complex amplitude distribution of a light wave after propagation in free space; U_{N-1}(x, y) represents a complex amplitude distribution of the target RGB-D image at a point (x, y) in the (N−1)^{th} depth layer, wherein N represents a total quantity of depth layers; and −zh′−(N−1) represents a reverse distance from the (N−1)^{th} depth layer to the holographic plane;
converting the Uₕ(x, y) into real part channel data and imaginary part channel data according to an Euler's formula; and
performing a shuffle operation based on the real part channel data and the imaginary part channel data to generate a multi-channel input matrix containing eight channels.

15. The hologram model training apparatus based on an unlabeled sample training set according to claim 8, wherein a calculation formula for reconstructing the multi-depth diffraction field of the multi-depth hologram through the layer-by-layer diffraction by using the ASM, and obtaining the focus-stacked image is specifically as follows:
$$R ( x , y ) = {\sum }_{n = 0}^{N - 1} {R}_{n} ( x , y ) ;$$
Rₙ(x, y)=ASM{U_{H}(x, y)}_{z=z}_{ₕ}_{+nΔz} □Mₙ(x, y);
ASM{U_{H}(x, y)}_{z=z}_{ₕ}_{+nΔz}=F⁻¹{F{U_{H}(x, y)}□H_{z=z}_{ₕ}_{+nΔz} (fₓ, f_{y})};
wherein R(x, y) represents a pixel value of a focus-stacked image at a point (x, y) in the multi-depth hologram; Rₙ(x, y) represents a focused light field at a point (x, y) in an n^{th} depth layer in the multi-depth hologram; n represents the n^{th} depth layer of the target RGB-D image, wherein n=[0, N−1], and N represents a total quantity of depth layers; U_{H}(x, y) represents a complex amplitude at the point (x, y) in the multi-depth hologram; Mₙ(x, y) represents a Boolean mask of the target RGB-D image at the point (x, y) in the n^{th} depth layer, and is used to distinguish light wave distributions in different depth layers; ASM { . . . } z represents calculation of a diffraction field of the multi-depth hologram at a reproduction distance, wherein z represents the reproduction distance, Zh represents a reproduction distance of an initial focal plane, and Δz represents a spacing between adjacent focal planes; F{ } represents a symbol representation of Fourier transform, and is used to convert a spatial domain signal into a frequency domain signal; F⁻¹{ } represents a symbol representation of inverse Fourier transform, and is used to convert the frequency domain signal into the spatial domain signal; Hz represents a transfer function, wherein zₕ represents the reproduction distance of the initial focal plane, and Δz represents the spacing between the adjacent focal planes; and fₓ and f_{y} respectively represent spatial frequency components in x and y directions.

16. The hologram model training apparatus based on an unlabeled sample training set according to claim 8, wherein a formula for calculating the model loss based on the target RGB-D image and the focus-stacked image is specifically as follows:
$$Loss = {L}_{1} \{ \sqrt{I ( x , y )} , \frac{\sum \sum \sqrt{I ( x , y )}}{\sum \sum R ( x , y )} ▯ R ( x , y ) \} ;$$
wherein Loss represents a loss of a current iteration; L1{ } represents a mean absolute error loss function; I(x, y) represents an amplitude of the target RGB-D image at a point (x, y); and R(x, y) represents a pixel value of a focus-stacked image at a point (x, y) in the multi-depth hologram.

17. The computer device according to claim 9, wherein a method for generating the intensity image and the depth image specifically comprises:
determining a row quantity h of a first original matrix and a preset aspect ratio of the intensity image;
multiplying the row quantity h of the first original matrix by the preset aspect ratio of the intensity image, performing a rounding operation, and obtaining a column quantity w of the first original matrix;
generating the first original matrix with the row quantity h and the column quantity w, wherein each element value in the first original matrix is randomly distributed between 0 and 255;
generating an intensity image with a width w1 and a height h1 based on the first original matrix by using an interpolation algorithm, wherein the w1 and the h1 satisfy the preset aspect ratio;
determining a row quantity h2 and a column quantity w2 of a second original matrix, wherein the h2 is less than or equal to the h1, and the w2 is less than or equal to the w1;
generating the second original matrix with the row quantity h2 and the column quantity w2, wherein each element value in the second original matrix is randomly distributed between 0 and 255; and
generating a depth image with the width w1 and the height h1 based on the second original matrix by using the interpolation algorithm.

18. The computer device according to claim 9, wherein the calculating a multi-depth diffraction field matrix of a target RGB-D image at a preset diffraction distance specifically comprises:
uniformly dividing the target RGB-D image into N depth layers based on a depth, calculating a complex amplitude distribution of each depth layer by using the ASM, and obtaining the multi-depth diffraction field matrix of the target RGB-D image, wherein Nis an integer, and each depth layer has an equal depth spacing, wherein
a calculation formula for the complex amplitude distribution is as follows:
Uₙ(x,y)=∧{Uₙ₋₁(x,y)}Δz′=\sqrt{I(x,y)}□exp[jφ₀]□Mₙ(x,y)+ASM{Uₙ₋₁(x,y)}□_{Δz}′□[1−Mₙ(x,y)]ASM{Uₙ₋₁(x,y)}Δz′=F⁻¹{F{Uₙ₋₁(x,y)}□H_{ΔZ′}(fₓ,f_{y})}H_{Δz′}(fₓ,f_{y})=exp[jkΔz′\sqrt{1−(λfₓ)²−(λf_{y})²}];
wherein n represents an n^{th} depth layer of the target RGB-D image, wherein n=[0, N−1], and N represents a total quantity of depth layers; Uₙ(x, y) represents a complex amplitude distribution of the target RGB-D image at a point (x, y) in the n^{th} depth layer; ∧{□} represents a symbol representation of an angular spectrum diffraction process, and is used to represent a process of propagating a light wave from a current depth layer to a next depth layer in the target RGB-D image; Δz′ represents the preset diffraction distance; I(x, y) represents an amplitude of the target RGB-D image at the point (x, y); j represents an imaginary unit, wherein, j²=−1; φ₀ represents an initial fluctuation state of the light wave; Mₙ(x, y) represents a Boolean mask of the target RGB-D image at the point (x, y) in the n^{th} depth layer, and is used to distinguish light wave distributions in different depth layers; ASM { . . . }Δz′ represents a process of calculating the preset diffraction distance by using the ASM, and is used to calculate a complex amplitude distribution of the light wave after propagation in free space; F{ } represents a symbol representation of Fourier transform, and is used to convert a spatial domain signal into a frequency domain signal; F⁻¹{ } represents a symbol representation of inverse Fourier transform, and is used to convert the frequency domain signal into the spatial domain signal; H_{Δz′}(fₓ, f_{y}) represents a transfer function, indicating a phase change of the light wave during the propagation in the free space, wherein and fₓ and f_{y} respectively represent spatial frequency components in x and y directions; and k represents a wave number, wherein k=2 π/λ, and λ represents a wavelength of the light wave.

19. The computer device according to claim 9, wherein the inputting the multi-depth diffraction field matrix into the hologram model, and obtaining a multi-depth hologram specifically comprises:
performing format conversion on a multi-depth diffraction field of the target RGB-D image, and obtaining a multi-channel input matrix; and
inputting the multi-channel input matrix into the hologram model, and obtaining the multi-depth hologram, wherein the hologram model comprises an input layer and an output layer, the input layer is configured to extract a feature from the multi-channel input matrix to generate a phase matrix, and input the phase matrix into the output layer, and the output layer is configured to reconstruct the phase matrix based on a phase reconstruction algorithm and obtain the multi-depth hologram.

20. The computer device according to claim 9, wherein the performing format conversion on a multi-depth diffraction field of the target RGB-D image, and obtaining a multi-channel input matrix specifically comprises:
calculating a complex amplitude distribution of the target RGB-D image from an (N−1)^{th} depth layer to a holographic plane according to a following formula:
Uₕ(x,y)=ASM{U_{N-1}(x,y)}_{-zh′-(N-1)Δz′};
wherein Uₕ(x, y) represents a complex amplitude distribution of the holographic plane at a point (x, y); ASM { . . . }Δz′ represents a process of calculating the preset diffraction distance by using the ASM, and is used to calculate a complex amplitude distribution of a light wave after propagation in free space; U_{N-1}(x, y) represents a complex amplitude distribution of the target RGB-D image at a point (x, y) in the (N−1)^{th} depth layer, wherein N represents a total quantity of depth layers; and −zh′−(N−1) represents a reverse distance from the (N−1)^{th} depth layer to the holographic plane;
converting the Uₕ(x, y) into real part channel data and imaginary part channel data according to an Euler's formula; and
performing a shuffle operation based on the real part channel data and the imaginary part channel data to generate a multi-channel input matrix containing eight channels.
